(19) United States
(12) Patent Application Publication
(10) Pub. No.: US 2008/0000882 A1
(43) Pub. Date: Jan. 3, 2008

(54) METHOD AND APPARATUS FOR A FOIL TO CONTROL HEAT FLOW FROM WELDING A DEVICE CASE

(76) Inventor: Stephen W. VanDerlick, Andover, MN (US)

Correspondence Address: SCHWEGMAN, LUNDBERG & WOESSNER, P.A., P.O. BOX 2938, MINNEAPOLIS, MN, 55402, US

(21) Appl. No.: 11/421,657

(22) Filed: Jun. 1, 2006

(51) Int. Cl. B23K 26/20; B23K 26/00

(52) U.S. Cl. 219/121.64

(57) ABSTRACT

One embodiment of the present subject matter includes an apparatus which includes an implantable case including a first opening shaped for passage of electronics, a seal connecting the cover and the first opening, the seal including a weld, electronics disposed in the case, and a foil strip backed with adhesive, oriented lengthwise with respect to the weld and disposed between the case and the electronics to reduce damage to the electronics from welding. In some embodiments, the adhesive holds the foil to a subcomponent.

### CROSS REFERENCE TO RELATED APPLICATIONS

The present application is related to the following commonly assigned U.S. Patent Publication which is incorporated by reference in its entirety: “Batteries Including a Flat Plate Design,” U.S. Patent Publication No. 2004/0127952, filed Feb. 7, 2003, which claims the benefit under 35 U.S.C 119(e) of U.S. Provisional Application Ser. No. 60/437,537 filed Dec. 31, 2002.

### TECHNICAL FIELD

This disclosure relates generally to packaging for implantable medical devices, and more particularly to a method and apparatus to control heat flow from welding a device case.

### BACKGROUND

Devices which include a welded case contain devices in that case which can be exposed to an unfavorably high amount of heat if they are disposed in the case near an area where the case is welded. This is true for a welded case of an overall device, as well as for a case of a device packaged inside the overall device. This heating is problematic for implantable devices, which are often sealed with a weld. Implantable devices include, but are not limited to, pacemakers, and defibrillators. Devices inside devices include batteries and capacitors. These devices provide little extra space to thermally insulate devices. In implantable devices, space is at a premium due, as space efficiency is required to improve patient comfort.

If a device is sensitive to heat, it is preferable to reduce the heat which is transmitted to that device during a welding process. What is needed is a method and apparatus which reduces heat transmitted to heat sensitive parts.

### SUMMARY

The above-mentioned problems and others not expressly discussed herein are addressed by the present subject matter and will be understood by reading and studying this specification.

One embodiment of the present subject matter includes an apparatus which includes an electronics case including a first portion and a second portion, a weld connecting the first portion of the electronics case and the second portion of the electronics case, electronics disposed in the electronics case and a foil backed with adhesive and disposed between the case and the devices, the foil positioned to reduce damage to the electronics from welding.

Another embodiment of the present subject matter includes a method which includes disposing devices in a device case including a first portion with a first opening defined by an edge, positioning a foil strip backed with foil adhesive between the edge and the devices and welding a second portion of the device case to the first portion along the edge, wherein the foil strip reduces damage caused by welding the second portion of the power source case to the first portion of the power source case.

A further embodiment of the present subject matter includes an apparatus which includes a device case, subcomponents disposed in the device case and heat resistant means for reducing damage to the subcomponents from welding, wherein the heat resistant means are disposed between the device case and the subcomponents.

Optional features within the scope of the present subject matter include a polyimide film disposed between foil and a device or subcomponent. Some embodiments use a pressure sensitive adhesive. Some embodiments partially apply an adhesive to a substrate. Some embodiments include a feedthrough as part of a seal sealing a case. Some embodiments includes a case including a butt joint. Some embodiments include a hermetic seal.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their legal equivalents.

### BRIEF DESCRIPTION OF THE DRAWINGS

FIG. 1A is a perspective view of a device showing a partial cut away, according to one embodiment of the present subject matter.

FIG. 1B is a cross section taken at line 1B-1B in FIG. 1A.

FIG. 2 is a partial cross section of an device which includes a foil which controls heat flowing to the device, according to one embodiment of the present subject matter.

FIG. 3 is a partial cross section of an device which includes a foil which controls heat flowing to the device, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

Many devices include an outer case. For example, implantable electronic devices often include an outer case which is compatible with implantation and which houses additional devices. Implantable devices which fall within the scope of the present subject matter include cardiac rhythm management devices, such as pacemakers and defibrillators. Various additional implantable devices also fall within the present scope. Such additional implantable devices include devices which stimulate the body during the administration of therapy, in various embodiments.

Packaged within such an outer case are additional devices, in various embodiments. Such additional devices include, in various embodiments, batteries, capacitors, electrical circuits and electromechanical sensors. Additional devices not listed herein also are used with the present subject matter, in various embodiments.

In some embodiments, the present subject matter includes batteries. Batteries, in various embodiments, include electrodes, such as anodes and cathodes, which are packaged in a battery case. Further discussion of batteries is included in paragraphs 98, 165-7, and 247 of United States Patent Publication 2004/0127952, which was filed Feb. 7, 2003, which has a common assignee and which is incorporated by reference.

In some embodiments, the present subject matter includes capacitors. Capacitors include electrodes, such as anodes and cathodes, which are packaged in a capacitor case, in various embodiments.

In some embodiments, the present subject matter includes electrical circuits packaged in an electrical circuit housing. An electrical circuit housing, in various embodiments, is polymeric. Electrical circuits include flex circuitry, in various embodiments. Other types of electrical circuitry additionally are used with the present subject matter, in various embodiments.

In various embodiments of the present subject matter, the outer case of a device also houses devices which do not have their own respective case. In some of these embodiments, a support structure is housed in an overall device. In various embodiments, a support structure includes polymers. In various embodiments, a support structure is used to support electronics. One embodiment uses a support structure to support flex circuitry. Additional insulative plastic structures are also used with the present subject matter.

The present subject matter includes casings which are sealed with a weld. A weld can be used to seal a first case portion to a second case portion, in various embodiments. In some embodiments, a weld seals a feedthrough to a case portion. In various embodiments, the present subject matter reduces heat which flows from a weld area to a packaged device. By reducing the heat which flows from a weld area to a packaged device, the present subject matter allows for better packaging efficiency. In embodiments which use an air gap to provide thermal insulation, the present subject matter allows for a reduction in the size of the air gap, which in turn improves packaging efficiency. As such, various embodiments provide for a smaller implantable device.

Welding is used in various embodiments because it is an efficient and cost effective way to join one case portion to another. A weld provides a hermetic seal, in some embodiments. Some embodiments of the present subject matter use a laser to weld. In addition to the welding disclosed herein, the present application incorporates by reference the subject matter disclosed in paragraphs 213, 215-224 of United States Patent Publication 2004/0127952, which has a common assignee and which was filed Feb. 7, 2003.

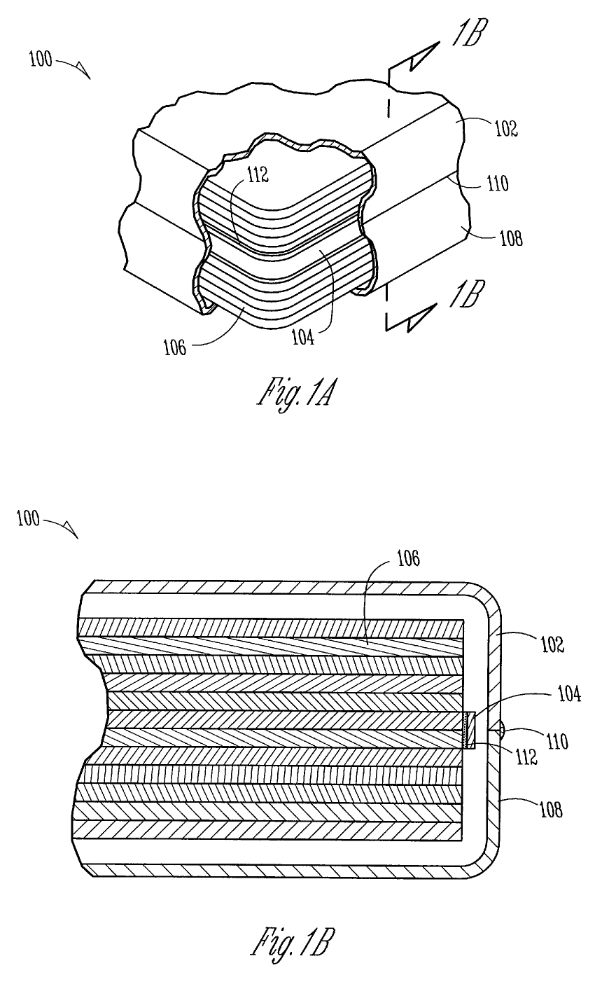

FIG. 1A is a perspective view of a device 100 showing a partial cut away, according to one embodiment of the present subject matter. FIG. 1B is a cross section taken at line 1B-1B in FIG. 1A. The pictured embodiment includes subcomponent 106.

In various embodiments, subcomponent 106 is a stack of electrodes, such as anodes and cathodes. Such a stack exists in some battery embodiments. The present subject matter is not limited to batteries. Some embodiments include capacitors. The present subject matter includes any subcomponent 106 which is sensitive to heat. This includes, but is not limited to, cardiac rhythm management circuitry, in some embodiments. In addition to battery stacks disclosed herein, the present application incorporates by reference the subject matter disclosed in paragraphs 135-6, 138, 154-7, 170-1, 191-6 of United States Patent Publication 2004/0127952, which has a common assignee and which was filed Feb. 7, 2003.

In addition to stack embodiments, various embodiments include electrodes which are in a jelly-roll configuration. The present subject matter is not limited to these electrode configurations, and other configurations fall within the present scope, in various embodiments.

Surrounding the subcomponent 106 is a foil 104, in various embodiments. In various embodiments, foil 104 reduces heat flow to the subcomponent 106 by isolating the subcomponent 106 from a heat source such as a weld along seam 110. In various embodiments, the foil 104 is disposed along the surface of subcomponent 106 such that the foil 104 is disposed between the seam 110 and the subcomponent 106. In various embodiments, the foil 104 extends along subcomponent 106, and away from seam 110, such that heat conducted to case portions 102, 108, does not flow in excess to subcomponent 106.

Seam 110 may include different joints, in various embodiments. Various embodiments include lip joints, step joints, lap joints, and butt joints. This list of possible joints is not exhaustive or exclusive, and other joints not listed herein additionally fall within the present scope. In various embodiments, seam 110 provides a hermetic seal.

In various embodiments, the foil 104 is a metallic foil. In various embodiments, the foil 104 includes, but is not limited to, thicknesses of from approximately 0.0005 inches thick to approximately 0.005 inches thick. In additional embodiments, the foil 104 is less than 0.0005 inches. The present subject matter additionally includes foils which are thicker than 0.005 inches.

In various embodiments, the device 100 is configured such that the foil 104 abuts one or more case portions. In additional embodiments, the foil 104 does not abut any case portions. Various embodiments use foil 104 to reduce heat transmitted to subcomponent 106 due to the creation of a weld along seam 110.

Various embodiments include adhesive 112. Foil 104, in various embodiments, is adhered to the surface of subcomponent 106. In additional embodiments, adhesive is used to adhere foil 104 to a case portion, such as case portion 108. For example, some embodiments first adhere a foil 104 to subcomponent 106, and then dispose subcomponent 106 in case portion 108. But some embodiments first adhere foil 104 to case portion 108, and then dispose subcomponent 106 into case portion 108.

The present subject matter is useful with foils which tend to distort during manufacturing. Thin foils are susceptible to crumpling. The present subject matter provides for using a foil such that the foil does not crumple. In various embodiments, the foil resists peeling. Adhesives disclosed herein provide respective resistances to peeling. Additionally, in various embodiments, the thickness of the foil 104 is selected based on the distance of the foil 104 from a weld.

In various embodiments, the foil 104 is strip shaped. In some embodiments, the foil 104 is longer than the seam 110. Some embodiments use a foil 104 which is not as long as the seal. In some embodiments, the foil 104 is a tape-like elongate strip which meets itself end to end. In various embodiments, the foil 104 is a continuous piece. In some embodiments, the foil 104 does not fully circumscribe the subcomponent 106.

In embodiments in which an adhesive is applied to a case portion which is welded to another case portion, the adhesive is applied so it does not break down due to the welding. For example, in some embodiments, the adhesive is applied to the strip along the edges of the strip so that the strip straddles a weld, with adhesive positioned away from a high heat area. In some of these embodiments, the adhesive will straddle the weld. In additional embodiments, the adhesive will straddle an area which is larger than the weld. It should be noted that the present subject matter is not limited to embodiments using one or more cup shaped case portions.

Various adhesives fall within the present scope. Adhesives which are resistant to electrolyte are used in various embodiments. Some of these embodiments dispose foil 104, adhesive 112 and subcomponent 106 in case portions 102, 108, which are then sealed together and filled with electrolyte. Pressure sensitive adhesives are used, in various embodiments. Some embodiments an adhesive which includes 467MP, which is a 3M product. 3M is a registered trademark of the 3M Company, which is incorporated in Delaware and is headquartered at 3M Center, 2501 Hudson Road St. Paul Minn. 55144. 467 MP is one example of an adhesive which falls within the present scope.

In some of these embodiments, subcomponent 106 includes a stack which is retained in alignment. In some embodiments of the present subject matter, foil 104 is used to retain the stack in alignment. In addition to stack embodiments in alignment as disclosed herein, the present application incorporates by reference the subject matter disclosed in paragraphs 112, 117 of United States Patent Publication 2004/0127952, which has a common assignee and which was filed Feb. 7, 2003.

In some embodiments, there exist terminal features which are connected to the subcomponent 106. In some of these embodiments, the foil 104 circumscribes the subcomponent 106 but for the area including a terminal feature.

Various embodiments include a feedthrough attached to a stack of electrodes. Such a stack exists in some battery embodiments. Such a stack also exists in some capacitor embodiments. In various embodiments, a seal is formed in the case at the joint of two case parts. In some of these embodiments, a feedthrough is sealed between the two case parts. In some of these embodiments, the feedthrough is welded to the case. In additional embodiments, the feedthrough is disposed through a single case part. In various embodiments, the feedthrough is not welded to the case. In some embodiments, the foil 104 is disposed along the battery stack edge face in areas where the feedthrough is not connected to the battery stack edge face. In some embodiments where a feedthrough is welded to an aperture in a case, a washer shaped foil is used to insulate a device from the weld used to weld the feedthrough to the aperture. In addition to the feedthrough embodiments disclosed herein, the present application incorporates by reference the subject matter disclosed in paragraphs 161-3 and 208 of United States Patent Publication 2004/0127952, which has a common assignee and which was filed Feb. 7, 2003.

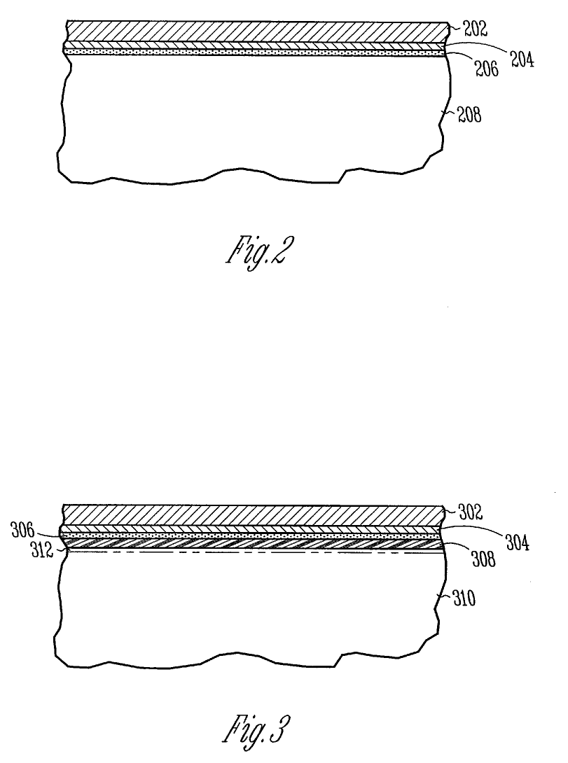

FIG. 2 is a partial cross section of a device which includes a foil which controls heat flowing to a device, according to one embodiment of the present subject matter. The pictured embodiment includes device 208. The pictured embodiment additionally includes case 202. Additionally, various embodiments include adhesive 206. Foil 204 is disposed along a surface of device 208, in various embodiments. Foil 204, in various embodiments, is adhered to the surface of device 208. As mentioned above, device 208 can be a battery, capacitor, electrical circuits, structure holding other devices, or any other heat sensitive object.

In various embodiments, adhesive 206 is applied to foil 204 prior to the application of foil 204 to device 208. But in various embodiments, the adhesive 206 is first applied to device 208, and then foil 204 is applied to adhesive 208. In some of these embodiments, the adhesive 206 is part of a tape film which has adhesive on both sides, and which is applied to device 208. In some embodiments, adhesive 206 is not part of such a tape film. In addition to the manufacturing processes disclosed herein, the present application incorporates by reference the subject matter disclosed in paragraphs 125 and 225 of United States Patent Publication 2004/0127952, which has a common assignee and which was filed Feb. 7, 2003. The application of a foil to device 208 can occur at different stages of these manufacturing processes, depending on the heat sensitivity of device 208 during assembly.

In some embodiments, adhesive 206 is applied to foil 204 intermittently along the surface of device 208. Such a design avoids using adhesive on the foil where there is no device 208 for the adhesive to stick to. An aperture extending through the device 208 at the area where the foil 204 covers the device 208 is one example of a use for such a design. Some embodiments of the present subject matter do not use adhesive near such features when applied to the device 208.

FIG. 3 is a partial cross section of a device which includes a foil which controls heat flowing to the device, according to one embodiment of the present subject matter. Various embodiments include a case 302. Various case 302 embodiments include, but are not limited to, one or more of aluminum, stainless steel, titanium or alloys thereof. Materials not listed expressly herein are additionally used with the present subject matter, in various embodiments. Various foil 304 embodiments include, but are not limited to, one or more of aluminum, stainless steel, titanium or alloys thereof. Materials not listed expressly herein are additionally used with the present subject matter, in various embodiments.

An adhesive 306 is included in various embodiments. Adhesive 306 is a pressure sensitive adhesive, as is discussed herein, in various embodiments. Also, various embodiments include a substrate 308. Substrate 308, in various embodiments, is polyimide. In some embodiments, the substrate 308 is an elongate strip. In addition to the substrate embodiments disclosed herein, the present application incorporates by reference the subject matter disclosed in paragraphs 172-3 of United States Patent Publication 2004/0127952, which has a common assignee and which was filed Feb. 7, 2003.

Polyimide resists breakdown under unfavorable heat, in various embodiments. Including a substrate 308 which is resistant to heat flow allows for laser welding of the case 302 while protecting device 310 from heat excessive heat flow, in various embodiments. A substrate 308 is additionally useful to provide rigidity to an assembly including adhesive, a substrate, and a foil. Such an assembly is easier for an operator to handle, in various embodiments.

In some embodiments, foil 304 is laminated to substrate 308. In some embodiments, a structure including a foil 304, adhesive 306, and a substrate 308 is adhered to device 310 with optional adhesive 312. Optional adhesive 312 is a pressure sensitive adhesive, in various embodiments, however the present subject matter includes additional adhesives.

Although specific embodiments have been illustrated and described herein, it will be appreciated by those of ordinary skill in the art that any arrangement which is calculated to achieve the same purpose may be substituted for the specific embodiment shown. This application is intended to cover adaptations or variations of the present subject matter. It is to be understood that the above description is intended to be illustrative, and not restrictive. Combinations of the above embodiments, and other embodiments will be apparent to those of skill in the art upon reviewing the above description. The scope of the present subject matter should be determined with reference to the appended claims, along with the full scope of equivalents to which such claims are entitled.

We claim:

1. An apparatus, comprising:
an electronics case including a first portion and a second portion;
a weld connecting the first portion of the electronics case and the second portion of the electronics case;
electronics disposed in the electronics case; and
a foil backed with an adhesive and disposed between the electronics case and the component, the foil positioned to reduce damage to the electronics due to heat from welding.

2. The apparatus of claim 1, wherein the electronics include cardiac rhythm management circuitry.

3. The apparatus of claim 1, further comprising a polyimide film disposed between a foil and the component.

4. The apparatus of claim 1, wherein the electronics include a stack of substantially planar electrodes.

5. The apparatus of claim 4, wherein the stack of substantially planar electrodes includes battery electrodes.

6. The apparatus of claim 1, further comprising an implantable device case in which the electronics case is disposed.

7. The apparatus of claim 6, wherein the implantable device case is hermetically sealed.

8. The apparatus of claim 1, further comprising a seal connecting the first portion of the electronics case and the second portion of the electronics case, the seal including the weld.

9. The apparatus of claim 8, wherein the seal includes a feedthrough.

10. The apparatus of claim 9, wherein the feedthrough is welded to the case.

11. The apparatus of claim 1, wherein the foil is a foil strip.

12. The apparatus of claim 11, wherein the foil strip is positioned lengthwise along the weld.

13. The apparatus of claim 1, wherein the adhesive includes a pressure sensitive adhesive.

14. The apparatus of claim 13, wherein the foil includes foil with adhesive entirely covering one side of the foil.

15. A method, comprising:
disposing electronics in an electronics case including a first portion with a first opening defined by an edge;
positioning a foil strip backed with foil adhesive between the edge and the devices; and
welding a second portion of the device case to the first portion along the edge,
wherein the foil strip reduces damage caused by welding the second portion of the device case to the first portion of the device case.

16. The method of claim 15, further comprising disposing the electronics case in an implantable device case.

17. The method of claim 15, further comprising adhering the foil strip to the electronics.

18. The method of claim 15, further comprising adhering the foil strip to the electronics case.

19. The method of claim 15, further comprising stacking a plurality of substantially planar battery electrodes into a stack which is included in the electronics.

20. The method of claim 19, further comprising securing the plurality of substantially planar electrodes to one another by applying the foil strip to the edges of at least two of the plurality of substantially planar battery electrodes.

21. The method of claim 15, wherein welding includes laser welding.

22. The method of claim 21, further comprising mating the first portion of the power source case the second portion of the power source case at a butt joint, wherein welding a second portion of the power source case to the first opening along the edge includes welding along the butt joint.

23. The method of claim 22, further comprising sealing a feedthrough to the electronics.

24. An apparatus, comprising:
an electronics case;
electronics disposed in the electronics case; and
heat resistant means for reducing damage to the electronics from welding,
wherein the heat resistant means are disposed between the electronics case and the electronics.

25. The apparatus of claim 24, wherein the electronics case includes a first portion and a second portion, with a seal connecting the first portion and the second portion.

26. The apparatus of claim 25, wherein the seal includes a weld.

27. The apparatus of claim 26, wherein the heat resistant means include a foil strip backed with foil adhesive, oriented lengthwise with respect to the weld, and disposed between the device case and the electronics.
